(19) United States
(12) Patent Application Publication
(10) Pub. No.: US 2006/0109658 A1
(43) Pub. Date: May 25, 2006

(54) Collapsible lampshade with bottom mounting hub

(76) Inventor: Hsih Bin Chou, Dong-Guan City (TW)

Correspondence Address: ZITO TLP, 26005 RIDGE ROAD, SUITE 203, DAMASCUS, MD, 20872, US

(21) Appl. No.: 10/997,744

(22) Filed: Nov. 24, 2004

(51) Int. Cl. F21V 1/06

(52) U.S. Cl. 362/351; 362/358; 362/352

(57) ABSTRACT

A lamp shade which can be collapsed to reduce its size for shipping, display and storage, having an upper ring, a lower ring, and a number of supports interconnecting, separating and supporting the upper and lower rings. In one embodiment, the supports are separate trapezoid-shaped single piece supports which are press-fit between said rings and are removed from between the rings for collapsing the lampshade. In another embodiment, the supports are separate U-shaped single piece supports, the upper ends of which are press-fit beneath said upper ring and the lower ends of which fit into receptacles on said lower ring, and which are removed from the ring and receptacles for collapsing the lampshade.

### RELATED APPLICATIONS

This application is related to U.S. application Ser. No. 10/615,496 filed Jul. 8, 2003.

### FIELD OF THE INVENTION

The present invention relates to lampshade frames which are covered with a flexible material and can be collapsed to occupy less space during shipping and storage. More specifically, the present invention is a collapsible lampshade with an upper ring and a lower ring, removable supports between the upper and lower rings, and a mounting spider with a mounting hub for mounting the lampshade on a lamp base.

### BACKGROUND OF THE INVENTION

A significant part of the sales price of a table lamp arises from the cost of transporting the lamp from the manufacturing plant to the retail sales store or to the purchaser and the cost for inventory space, shelf space and storage space. Because the shade often forms a substantial portion of the lamp's total packaging volume, the shade disproportionately affects the shipping, display and storage cost and ultimately the sales price of the lamp. The present invention is designed to overcome this shortcoming by providing an inexpensive and collapsible shade structure. During shipment, storage and display, the shade may be collapsed to minimize its packaging volume, thereby reducing the lamp's size and cost.

### SUMMARY OF THE INVENTION

A collapsible lampshade is disclosed having an upper ring, a lower ring, and a number of supports interconnecting and spacing apart the upper and lower rings. The lampshade also has a flexible cover, such as cloth, fabric or paper attached to the upper and lower rings, and a mounting spider assembly to facilitate mounting of the lampshade onto a variety of lamps. The supports are removed from the shade to allow the shade to be collapsed.

In a first exemplary embodiment, as shown in FIGS. 1A, 1B, 2A, 2B, 3A, 3B and 3C, the supports are rectangular or trapezoid-shaped. The supports have two curved ends and two straight sides. The curved ends are curved to match the upper and lower rings. One curved end is placed against its respective upper or the lower ring. Next, the opposite end is placed against the other ring. The supports are held in place by the tension of the cover. The straight sides of the supports hold the upper and lower rings parallel and spaced apart to form the frame structure for the shade. The supports are not attached to either ring. The supports are removed from both rings prior to collapsing and shipping the lampshade. When collapsed for shipping, the lampshade has four separate pieces, the two rings with the attached cover are one piece and each of the three supports are separate, unattached pieces.

In a second exemplary embodiment, as shown in FIGS. 4A-4C and 5A-5D, the supports are U-shaped with one end and two straight sides. The end of each support is curved to match the upper ring. The curved end is first placed against the upper ring. Next, the ends of the two legs of each support are pressed upward and inward. The ends of the supports are then aligned with boots on the lower ring and are inserted into the boots and released. The supports hold the upper and lower rings parallel and spaced apart to form the frame structure for the shade. The supports are not attached to either ring, in the exemplary embodiment as illustrated. The supports are removed from both rings prior to collapsing and shipping the lampshade. When collapsed for shipping, the lampshade has four separate pieces, the two rings and the cover are one piece and each of the three supports are separate unattached pieces.

In a third exemplary embodiment, as shown in FIGS. 6A, 6B 7A and 7B, the U-shaped supports are inserted into sockets which are attached to the lower ring.

In the illustrated exemplary embodiments, three supports are utilized to interconnect the upper ring and the lower ring, however a lesser or a greater number can be used without departing from the teachings of the present invention. Also in illustrated exemplary embodiments, boots and sockets are shown as receptacles associated with a particular support style. Either boots or sockets or any other type of device known to those skilled in the art may be used with either style of support to fix the bottom of the supports against the lower ring without departing from the teachings of the present invention.

### BRIEF DESCRIPTION OF THE DRAWINGS

Exemplary embodiments of the invention are discussed hereinafter in reference to the drawings, in which:

FIG. 1A a side view of the outside of the lampshade of the present invention fully assembled. The intermediate support is generally depicted in the assembled position.

FIG. 1B is a side view of the outside of the lampshade of the present invention, disassembled and partially folded. The lampshade is generally depicted without intermediate supports, which are removed from the lampshade before the lampshade is collapsed.

FIG. 2A is an assembly view of the structure of the first exemplary embodiment of the lampshade. The cover is omitted for clarity.

FIG. 2B is a view of the flattened portion 14 at the center of the circumferential yoke 10 with centering notch 15 of the first exemplary embodiment of the lampshade.

FIG. 3A is a view of the structure of the first exemplary embodiment of the lampshade fully assembled. The cover is omitted for clarity.

FIG. 3B is a view of the flattened portion 14 of the circumferential yoke 10 of the intermediate support of the first exemplary embodiment in position against the upper ring 4, held in place by guide post 5 after assembly.

FIG. 3C is a view of the circumferential base 12 of the intermediate support of the first exemplary embodiment in position against the lower ring 7 held in place by a retaining nub 8 after assembly.

FIG. 3D is a side view of the lower ring assembly.

FIG. 4A is an assembly view of the structure of the second exemplary embodiment of the lampshade. The cover and mounting spider assembly are omitted for clarity.

FIG. 4B is a view of the flattened portion 14 at the center of the circumferential yoke 10 with centering notch 15 of the second exemplary embodiment of the lampshade. (This view depicts the same arrangement as in FIG. 2B, but is repeated here for convenience.)

FIG. 4C is a view of the lower ring of the second exemplary embodiment with boot 28, comprised of a socket 30 and sleeve 31, and slide stops 29.

FIG. 5A is a view of the structure of the second exemplary embodiment of the lampshade fully assembled. The cover and mounting spider assembly are omitted for clarity.

FIG. 5B is a view of the central portion 14 of the circumferential yoke 10 of the intermediate support of the second exemplary embodiment in position against the upper ring 4, held in place by guide post 5 after assembly. (This view depicts the same arrangement as in FIG. 3B, but is repeated here for convenience.)

FIG. 5C is a detailed view of boot 28 showing sleeve 31, socket 30 and slide stops 29 on lower ring 27 of the second exemplary embodiment.

FIG. 5D is a view of the lower end of the vertical rib 11 of the intermediate support in place inside socket 30 of boot 28 of lower ring 27 after assembly of the second exemplary embodiment.

FIG. 6A is a partial-assembly view of the lower ring assembly 32 of the structure of the third exemplary embodiment of the lampshade. The cover and mounting spider assembly are omitted for clarity.

FIG. 6B is an additional view of socket 34 with hole 35 on lower ring 33 of the third exemplary embodiment.

FIG. 7A a view of the structure of the third exemplary embodiment of the lampshade fully assembled. The cover and mounting spider assembly are omitted for clarity.

FIG. 7B is a view of the lower end of the vertical rib 11 of the intermediate support in place inside hole 35 of socket 34 of lower ring 33 after assembly of the third exemplary embodiment.

### DETAILED DESCRIPTION OF PREFERRED EXEMPLARY EMBODIMENTS

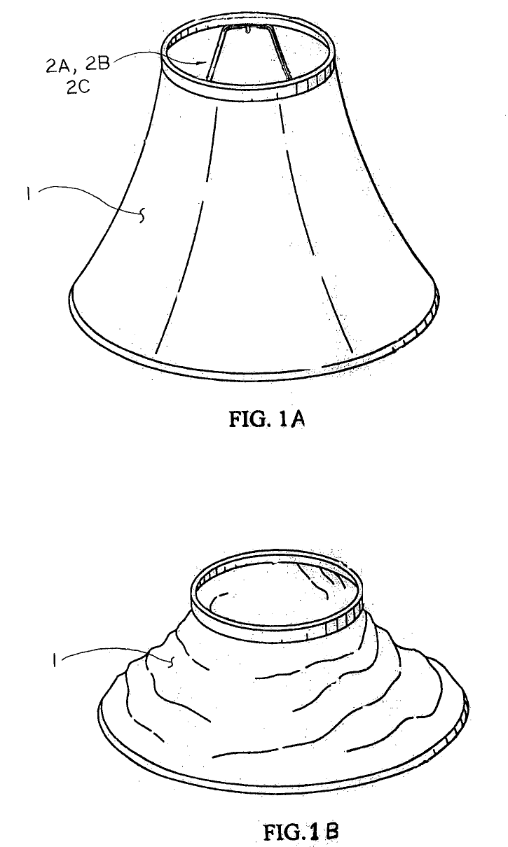

In each of the exemplary embodiments of the lampshade of the present invention, as illustrated in FIG. 1A, the lampshade has a cover 1, which can be made of any suitable flexible material such as cloth, fabric or paper, and a frame 2A. With portions of frame 2A removed, cover 1 collapses as shown in FIG. 1B.

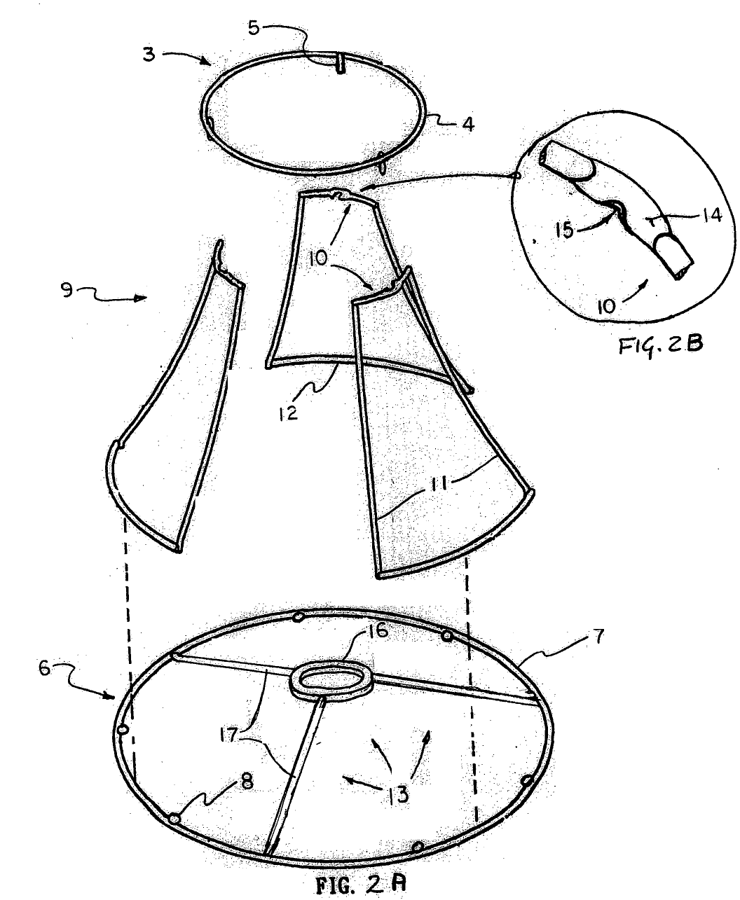

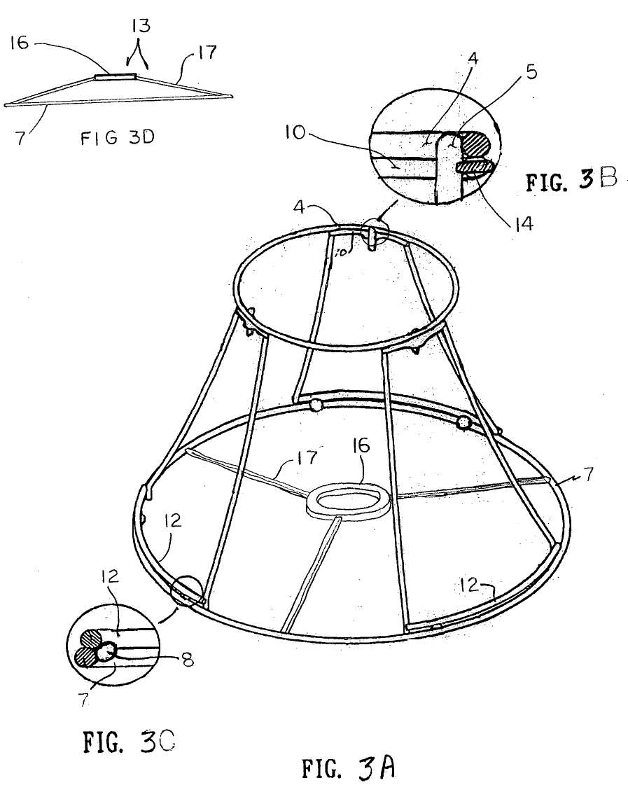

As illustrated in FIGS. 2A and 3A, the first embodiment of frame 2A has five separate components: an upper assembly 3 comprised of upper ring 4 and a number of guide posts 5, a lower assembly 6 comprised of lower ring 7 with retaining nubs 8 and mounting spider assembly 13, and intermediate supports 9, each comprised of one circumferential yoke 10, two vertical ribs 11 and one circumferential base 12. The frame is preferably made of metal but can be made of any other suitably rigid material.

Each of intermediate supports 9 is trapezoidal-shaped. The upper circumferential yoke 10 of intermediate support 9 is comprised of a generally cylindrical bar, curved to the radius of the upper ring 4 with a portion of its length at the center 14 flattened in a plane coplanar with the arc of the yoke 10 itself as shown in FIG. 2B. A notch 15 is cut into the center of the inner edge of the flattened portion of the bar. This notch serves as a guide for centering and then stabilizing intermediate support 9 during assembly. Circumferential base 12 is also generally cylindrical and is curved to the radius of lower ring 7.

Guide posts 5 are attached to the inside of upper ring 4 as shown in FIG. 3B and extend vertically downward. Retaining nubs 8 are attached to the upper inside of lower ring 7 as shown in FIG. 3C.

Mounting spider assembly 13 is comprised of a central mounting hub 16 connected to a number of spider supports 17. Spider supports 17 are attached to the inside of lower ring 7. Spider supports 17 are angled upward so as to raise hub 16 above the plane of ring 7 as better illustrated in FIG. 3D. This will hide the bulb within the lampshade. The mounting spider 13, and in particular mounting hub 16 is configured so that the lampshade can be mounted on a standard lamp base in the manner common for table lamps, floor lamps and other lamps having shades.

As illustrated in FIG. 1A, cover 1 is attached to upper ring 4 and lower ring 7.

To assemble the lampshade, each of the three intermediate supports 9 are placed in position between the upper and lower rings 4 and 7, as illustrated in FIG. 3A. To install each intermediate support 9, first the upper circumferential yoke 10 is placed against the lower surface of upper ring 4 as illustrated in FIGS. 3A and 3B, with notch 15 aligned with guide post 5. Next, lower circumferential base 12 is pressed inward, up and over nubs 8 and on top of lower ring 7. Its final position is illustrated in FIG. 3C. In the positions as described above, both yolk 10 and base 12 are now lodged against the inside of cover 1 (not illustrated), and the center of each lower circumferential base 12 is aligned approximately below the center of the corresponding upper circumferential yoke 10. The supports are held in place by the tension of the cover 1 and correspondingly, intermediate supports 9 hold upper and lower rings 4 and 7 parallel and spaced apart to form the frame structure 2A for the shade. The intermediate supports 9 are not permanently attached to either ring but are simply held in place by being wedged between the rings, the posts or nubs and the cover.

The supports 9 are removed from between rings 4 and 7 to enable collapsing for storing or shipping the lampshade. The lampshade cover 1 lies flat when supports 9 are removed.

FIG. 3A illustrates the fully assembled lampshade of the first exemplary embodiment with all supports in place (the cover is omitted for clarity). The first exemplary embodiment discloses a lampshade having three guide posts, three nubs, three intermediate supports and a mounting spider with three spider supports. The lampshade can have more or less of these objects without departing from the scope of the present invention.

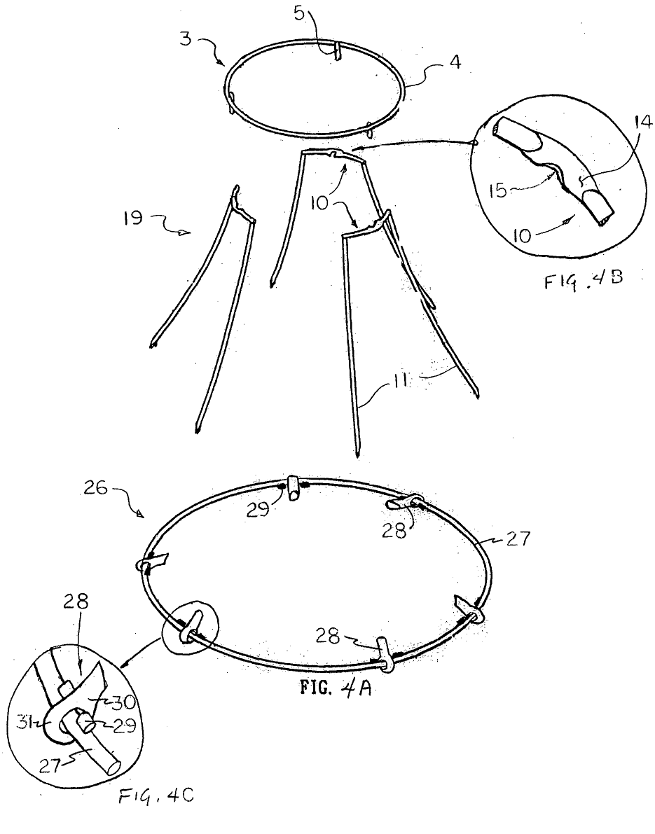

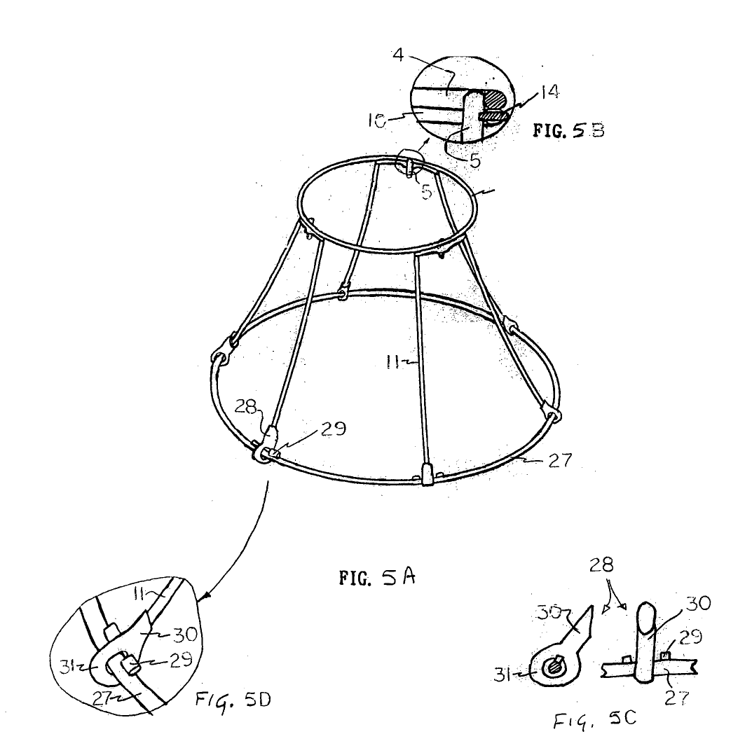

FIGS. 1A, 1B, 4A and 5A illustrate a second exemplary embodiment of the collapsible lampshade. In this embodiment, the lampshade has a frame 2B and a cover 1. Frame 2B has an upper assembly 3 comprised of upper ring 4 and a number of guide posts 5, a lower assembly 26 comprised of lower ring 27 with boots 28 and slide stops 29 and mounting spider assembly 13 (as shown in FIG. 2A, not shown in FIG. 4A or 5A for clarity), and intermediate supports 19, each comprised of one circumferential yoke 10 and two vertical ribs 11. The frame is preferably made of metal but can be made of any other suitably rigid material.

Each of intermediate supports 19 is inverted U-shaped. The upper circumferential yoke 10 of intermediate support 19 is comprised of a generally cylindrical bar, curved to the radius of the upper ring 4 with a portion of its length at the center 14 flattened in a plane coplanar with the arc of the yoke 10 itself as shown in FIG. 4B. A notch 15 is cut into the center of the inner edge of the flattened portion of the bar. This notch serves as a guide for centering and then stabilizing intermediate support 19 during assembly. There is no circumferential support base in this embodiment.

Guide posts 5 are attached to the inside of upper ring 4 as shown in FIG. 5B and extend vertically downward.

Boots 28 are shown in detail in FIG. 5C. Each boot 14 consists of a socket 30 and a sleeve 31. Ring 27 passes through the sleeve 31 on boot 28 such that the boot is able to rotate radially about ring 28. The socket 30 of boot 28 is tubular in shape extending from the sleeve 31 with an open end. The open end can be cut perpendicular to the axis of the socket, or can be cut at an angle as shown in FIG. 5C. The slide stops 29 are comprised of any suitable and suitably shaped material attached to the lower ring 27 on each side of each boot 28 such that the slide stops 29 prevent lateral movement of the boots.

The remaining features of the second exemplary embodiment are identical to the first exemplary embodiment.

To assemble the lampshade, each of the three intermediate supports 19 are placed in position between the upper and lower rings 4 and 27, as illustrated in FIG. 5A. To install each intermediate support 19, first the upper circumferential yoke 10 is placed against the lower surface of upper ring 4 as illustrated in FIGS. 5A and 5B, with notch 15 aligned with guide post 5. Next, the lower end of each of the vertical ribs 11 of each support is compressed inward and upward, toward the upper circumferential yoke 10, bowing each rib slightly to allow it to slip into socket 30. As each rib 16 is bowed, the corresponding boot 28 is rotated to permit the end of the rib to slide into the opening at the socket end 30 of the boot. When the rib is engaged in the boot, the bowing of the rib is released. The rib penetrates the socket of the boot causing the boot to rotate naturally to align its radial axis with the radial axis of the vertical rib and seat in boot 28 as illustrated in FIG. 5C. The supports and boots are held in place by the tension of the cover 1 and correspondingly, intermediate supports 19 hold upper and lower rings 4 and 27 parallel and spaced apart to form the frame structure 2B for the shade. The intermediate supports 19 are not permanently attached to either ring but are simply held in place by being wedged between the upper ring, the posts or boots and the cover.

The supports 19 are removed by bowing ribs 11 and rotating boots 28 toward the center of ring 27 and then removing the ends of ribs 11 from the boot. Then the yolk is removed from its wedged position against ring 4. This enables the lampshade to be collapsed for storing or shipping. The lampshade cover 1 lies flat when the intermediate supports are removed.

FIG. 5A illustrates the fully assembled lampshade of the second exemplary embodiment with all supports in place (the cover 1 and mounting spider 13 are omitted for clarity). The first exemplary embodiment discloses a lampshade having three guide posts, six boots, three intermediate supports and a mounting spider with three spider supports. The lampshade can have more or less of these objects without departing from the scope of the present invention.

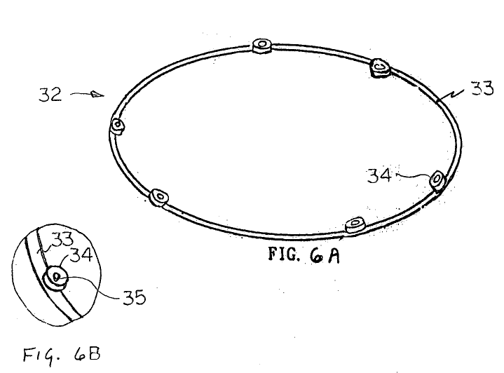

FIGS. 1A, 1B, 6A and 7A illustrate a third exemplary embodiment of the collapsible lampshade frame. This embodiment is substantially similar to the second exemplary embodiment except that it includes a frame 2C. All of the features of frame 2C are identical to those of frame 2B with the exception of the lower ring assembly. Frame 2C has a lower ring assembly 32 which comprises a lower ring 33 and sockets 34. The sockets 35 each have a hole 35 on the topside and are shown in detail in FIG. 6B. All of the other features of this exemplary embodiment are identical to those of the second exemplary embodiment.

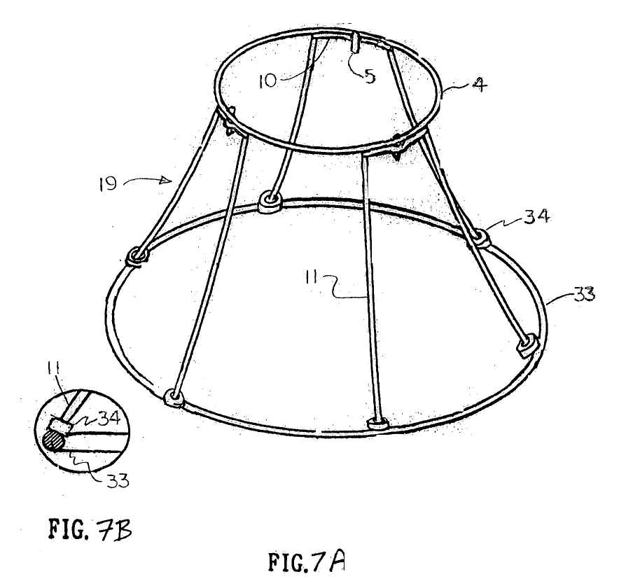

Assembly of the lampshade is identical to the second exemplary embodiment with the exception of the installation of the vertical ribs 11. In this embodiment, the lower end of each of the vertical ribs 11 of each support 19 is compressed inward and upward, toward the upper circumferential yoke 10, bowing each rib slightly to allow it to slip into a socket 34 as illustrated in FIG. 7B. When the rib 11 is engaged in the socket 34, the rib is released. The rib penetrates the hole 35 of the socket and rests against the surface of the lower ring 33.

The supports 19 are removed by bowing ribs 11 and pulling them toward the center of ring 33, thus removing the ends of the ribs from sockets 34. Then the yolk is removed from its wedged position against ring 4. This enables the lampshade to be collapsed for storing or shipping. The lampshade cover 1 lies flat when the intermediate supports are removed.

FIG. 7A illustrates the fully assembled lampshade of the first exemplary embodiment with all supports in place (the cover 1 and mounting spider 13 are omitted for clarity). The third exemplary embodiment discloses a lampshade having three guide posts, six sockets, three intermediate supports and a mounting spider with three spider supports. The lampshade can have more or less of these objects without departing from the scope of the present invention.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed is:

1. A collapsible lampshade, comprising:
an upper ring with generally vertical guide posts;
a lower ring;
a number of removable, generally U-shaped supports having a flattened apex with a vertical notch, two legs with ends and a base;
a cover attached to said upper and lower rings;
a mounting hub connected to said lower ring by struts; and
a plurality of receptacles attached to said lower ring, wherein:
the apex of each of said generally U-shaped supports is pressed against said upper ring and each said vertical notch is aligned with said generally vertical guide post; and
each of said ends of said generally U-shaped supports is inserted into one of said receptacles.

2. The collapsible lampshade of claim 1, wherein:
said supports are elastically bowed and press fit between said upper ring and said receptacles on said lower ring to space apart said rings, maintaining tension on said cover which maintains said supports in position between said rings.

3. The collapsible lampshade of claim 2, wherein:
said lampshade collapses when said supports are removed from between said rings, relieving said tension on said cover and allowing said shade to collapse to a flat configuration.

4. The collapsible lampshade of claim 1, wherein:
the apex of each U-shaped support is curved to match the curve of said upper ring.

5. A collapsible lampshade, comprising:
an upper ring with generally vertical guide posts;
a lower ring with retaining nubs;
a number of removable, generally trapezoidal shaped supports;
a cover attached to said upper and lower rings; and
a mounting hub connected to said lower ring by struts, wherein:
a first end of each of said generally trapezoidal shaped supports has a flattened portion with a vertical notch and is pressed against said upper ring with said notch aligned with said generally vertical guide posts; and
the opposite end of each of said generally trapezoidal supports is pressed over said retaining nubs and against said lower ring.

6. The collapsible lampshade of claim 5, wherein:
the other two sides of each of said supports extend between and separate said upper and lower rings.

7. The collapsible lampshade of claim 6, wherein:
said supports are elastically bowed and press fit between said rings to space apart said rings, maintaining tension on said cover which maintains said supports in position between said rings.

8. The collapsible lampshade of claim 7, wherein:
said lampshade collapses when said supports are removed from between said rings, relieving said tension on said cover and allowing shade to collapse to a flat configuration.

9. The collapsible lampshade of claim 5, wherein:
said first end of each support is curved to match the curve of said upper ring; and said opposite end is curved to match the curve of said lower ring.
